(19) United States
(12) Patent Application Publication
(10) Pub. No.: US 2016/0271429 A1
(43) Pub. Date: Sep. 22, 2016

(54) BREATHING APPARATUS

(71) Applicant: SHIGEMATSU WORKS CO., LTD., Tokyo (JP)

(72) Inventors: Yuki HANAOKA, Saitama (JP); Kenichi ONO, Saitama (JP); Hiroyuki IDE, Saitama (JP)

(21) Appl. No.: 15/030,135

(22) PCT Filed: Apr. 28, 2014
(86) PCT No.: PCT/JP2014/061816

§ 371 Date: Apr. 18, 2016

(30) Foreign Application Priority Data
Oct. 17, 2013 (JP) 2013-216339

(51) Int. Cl. A62B 18/08; A62B 9/02; A62B 18/00; A62B 18/10; A62B 23/02; A62B 7/10; A62B 18/02

(52) U.S. Cl. CPC A62B 18/08; A62B 7/10; A62B 9/02; A62B 18/02; A62B 18/10; A62B 23/025; A62B 18/025; A62B 18/006

(57) ABSTRACT

An object of the present invention is to provide a breathing apparatus whose a breath monitoring apparatus does not comprise an inhale valve or an exhale valve and whose number of elements is less than that of the conventional breathing apparatus. A breathing apparatus comprises a face piece for covering the whole face or part of the face, an inhale valve, an exhale valve, a voice conductor, a motor fan for supplying external air into the face piece through the inhale valve, a filter for cleaning the external air sucked into the motor fan, a breath monitoring apparatus not comprising the inhale valve or the exhale valve, and a controller for controlling the operation of the motor fan synchronously with the breath based on the detection signal from the breath monitoring apparatus, wherein the inhale valve, the exhale valve, the voice conductor, the motor fan, the filter, the breath monitoring apparatus and the controller are attached to the face piece, and wherein the breath monitoring apparatus detects deflection of a vibration member of the voice conductor.

### TECHNICAL FIELD

The present invention relates to a breathing apparatus.

### BACKGROUND ART

In Patent Document No. 1, the applicant of the present application disclosed a breathing apparatus comprising a face piece for covering the whole face or part of the face, an inhale valve, an exhale valve, a motor fan for supplying external air into the face piece through the inhale valve, a filter for cleaning the external air sucked into the motor fan, a breath monitoring apparatus not comprising the inhale valve or the exhale valve, and a controller for controlling the operation of the motor fan synchronously with the breath based on the detection signal from the breath monitoring apparatus, wherein the inhale valve, the exhale valve, the motor fan, the filter, the breath monitoring apparatus and the controller are attached to the face piece, and wherein the breath monitoring apparatus comprises a diaphragm covering an opening formed in the face piece, a magnet attached to the diaphragm and a Hall element attached to the face piece and opposing the magnet.

The breathing apparatus of Patent Document No. 1 has an advantage in that micro particulates of dust, water, etc. contaminating the inhaled air or the exhaled air do not readily adhere to the sensor to foul it, and therefore, deterioration of the accuracy of the breath monitoring with aging does not readily occur because the breath monitoring apparatus does not comprise the inhale valve or the exhale valve.

### PRIOR ART DOCUMENT

### Patent Document

Patent Document No. 1: Japanese Patent Laid-Open No. 2009-136521

### DISCLOSURE OF INVENTION

### Problem to be Solved

As shown in FIG. 1, a breathing apparatus fabricated as an actual product according to Patent Document No. 1 comprises, in addition to the aforementioned elements, a voice conductor 10 attached to the front surface of the face piece so as to radiate the voice of the user of the breathing apparatus to the outside. As a result, the actual product comes to comprise an inhale valve, an exhale valve attached to one side surface of the face piece, a filter, a breath monitoring apparatus attached to the other side surface of the face piece, and a voice conductor attached to the front surface of the face piece. Thus, the actual product has a disadvantage in that it comprises many elements.

The present invention is directed to solving the aforementioned problem. An object of the present invention is to provide a breathing apparatus whose breath monitoring apparatus does not comprise an inhale valve or an exhale valve and whose number of elements is less than that of the actually fabricated breathing apparatus product of Patent Document No. 1.

### Means for Achieving the Object

In accordance with the present invention, there is provided a breathing apparatus comprising a face piece for covering the whole face or part of the face, an inhale valve, an exhale valve, a voice conductor, a motor fan for supplying external air into the face piece through the inhale valve, a filter for cleaning the external air sucked into the motor fan, a breath monitoring apparatus not comprising the inhale valve or the exhale valve, and a controller for controlling the operation of the motor fan synchronously with the breath based on the detection signal from the breath monitoring apparatus, wherein the inhale valve, the exhale valve, the voice conductor, the motor fan, the filter, the breath monitoring apparatus and the controller are attached to the face piece, and wherein the breath monitoring apparatus detects deflection of a vibration member of the voice conductor.

In the breathing apparatus in accordance with the present invention, a vibration member of the voice conductor serves also as an element of a breath monitoring apparatus. Thus, the number of elements of the present breathing apparatus becomes less than that of the breathing apparatus fabricated as an actual product according to Patent Document No. 1.

In accordance with a preferred aspect of the present invention, the breath monitoring apparatus comprises a magnet attached to the vibration member of the voice conductor and a Hall element disposed opposite to the magnet.

The Hall element is a magnetometric sensor. Therefore, the accuracy of detection by the Hall element is not readily degraded even if particulates of dust, water, etc. contaminating the internal air of the face piece adhere to the Hall element.

In accordance with a preferred aspect of the present invention, the breath monitoring apparatus comprises a reflection member attached to the vibration member of the voice conductor and an optical sensor provided with a light emitting member and a light receiving member and disposed opposite to the reflection member.

A combination of a reflection member and an optical sensor can be adopted instead of the combination of the magnet and the Hall element.

In accordance with a preferred aspect of the present invention, the vibration member of the voice conductor is a formed sheet body capable of keeping a flat condition without being imparted with tensile force during non-loading time.

A sheet body can be processed to be a formed sheet body capable of keeping a flat condition even if not imparted with tensile force during non-loading time. The formed sheet body constituting the vibration member of the voice conductor in accordance with the present invention can keep a flat condition, that is, does not become loose, even if not imparted with tensile force during non-loading time, so that it can radiate the voice of a user of the breathing apparatus to the outside. Although the structure of the vibration member comprising the formed sheet body is complicated, the body of the voice conductor becomes simple overall because the voice conductor does not need any member for imparting tensile force to the vibration member.

In accordance with a preferred aspect of the present invention, the vibration member of the voice conductor is a circular shaped formed sheet body provided with many coaxially disposed annular corrugations at a center portion exclusive of an outer peripheral portion.

A circular shaped formed sheet body provided with many coaxially disposed annular corrugations at a center portion exclusive of an outer peripheral portion has an appropriate rigidity, so that it stay flat without being imparted with tensile force during non-loading time.

In accordance with a preferred aspect of the present invention, the vibration member of the voice conductor is a sheet body capable of keeping a flat condition, while being imparted with tensile force during non-loading time.

A vibration member comprising a simple sheet body has an advantage in that its structure is simple. However, it becomes necessary to provide the voice conductor with a member for imparting tensile force to the vibration body. Thus, the structure of the voice conductor becomes complicated as a whole. Moreover, the sheet body is easily creased with wrinkles when imparted with tensile force.

In accordance with a preferred aspect of the present invention, the detection signal from the breath monitoring apparatus is input to the controller through a low-pass filter.

When the vibration member of the voice conductor resonates with the voice of a user of the breathing apparatus, high frequency vibration of the vibration member of the voice conductor may occur at an amplitude larger than that due to the breath of the user of the breathing apparatus. In this case, the breath monitoring apparatus detects the high frequency vibration of the vibration member, the motor fan repeats increase/decrease of fan speed or ON/OFF in a short cycle based on the detection signal from the breath monitoring apparatus, a battery for driving the motor fan discharges rapidly, a brush of the motor fan rapidly wears down, and electronic components incorporated into the controller rapidly deteriorate. When the detection signal of the breath monitoring apparatus is input to the controller through the low-pass filter, high frequency components due to resonance of the voice of the user of the breathing apparatus and the vibration member of the voice conductor are removed from the detection signal, so that only low frequency components due to the breath of the user of the breathing apparatus are input to the controller. Thus, rapid discharge of the battery for driving the motor fan, rapid wearing of the brush of the motor fan, and rapid deterioration of the electronic components incorporated into the controller are prevented.

In accordance with a preferred aspect of the present invention, the detection signal from the breath monitoring apparatus is input to the controller through an amplifier.

Deflection of the vibration member of the voice conductor due to fluctuation of internal pressure of the face piece caused by the breath of the user of the breathing apparatus is small. Therefore, the detection signal of the breath monitoring apparatus is desirably input to the controller through an amplifier so as to increase accuracy of control of the motor fan. Instead of installing the amplifier, it is possible to increase the detection signal resolution of the controller, or increase the magnetic force of the magnet attached to the vibration member of the voice conductor, or increase the sensitivity of the Hall element attached to the face piece.

In accordance with a preferred aspect of the present invention, the breath monitoring apparatus, the voice conductor and the controller are assembled as a unitary body so as to form a unit, and the unit is detachably connected to an opening formed in the face piece.

The work of assembling the breathing apparatus becomes easy because the breath monitoring apparatus, the voice conductor and the controller are assembled as a unitary body so as to form a unit and the unit is detachably connected to an opening formed in the face piece.

### BRIEF DESCRIPTION OF THE DRAWINGS

FIG. 1 is a set of structural views of a breathing apparatus fabricated as an actual product according to Patent Document No. 1. (a) is a side sectional view and (b) is a front view.

FIG. 2 is a set of structural views of a breathing apparatus in accordance with a preferred embodiment of the present invention. (a) is a side sectional view and (b) is a front view.

FIG. 3 is an exploded perspective view of a unit constituted of a voice conductor, a breath monitoring apparatus and a controller assembled into a unitary body.

FIG. 4 is a block diagram of a controller provided for the breathing apparatus in accordance with a preferred embodiment of the present invention.

FIG. 5 is a perspective view of a variation of a vibration member of the voice conductor.

FIG. 6 is a perspective view of a variation of a vibration member of the voice conductor.

FIG. 7 is a perspective view of a variation of a vibration member of the voice conductor.

FIG. 8 is a side sectional view of a breathing apparatus in accordance with another preferred embodiment of the present invention.

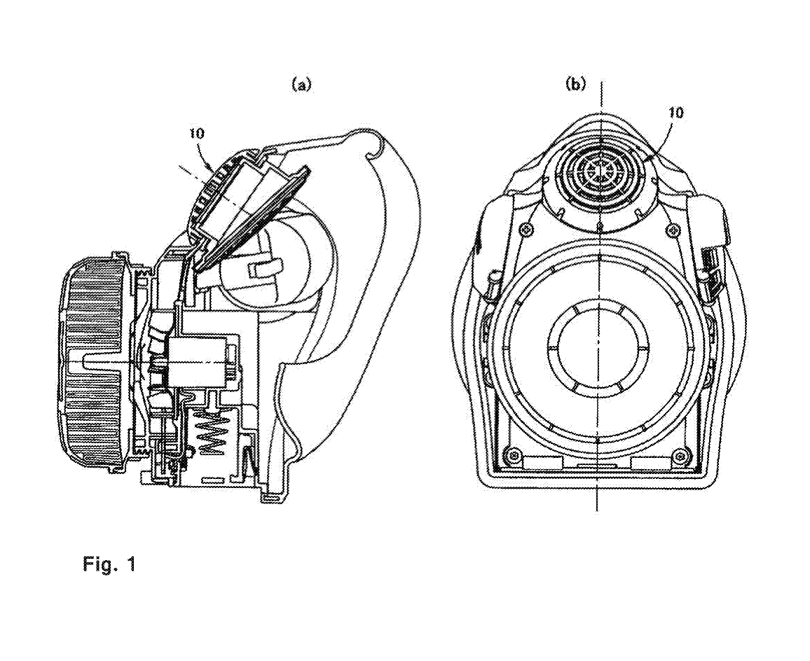

### MODES FOR CARRYING OUT THE INVENTION

A breathing apparatus in accordance with a preferred embodiment of the present invention will be described.

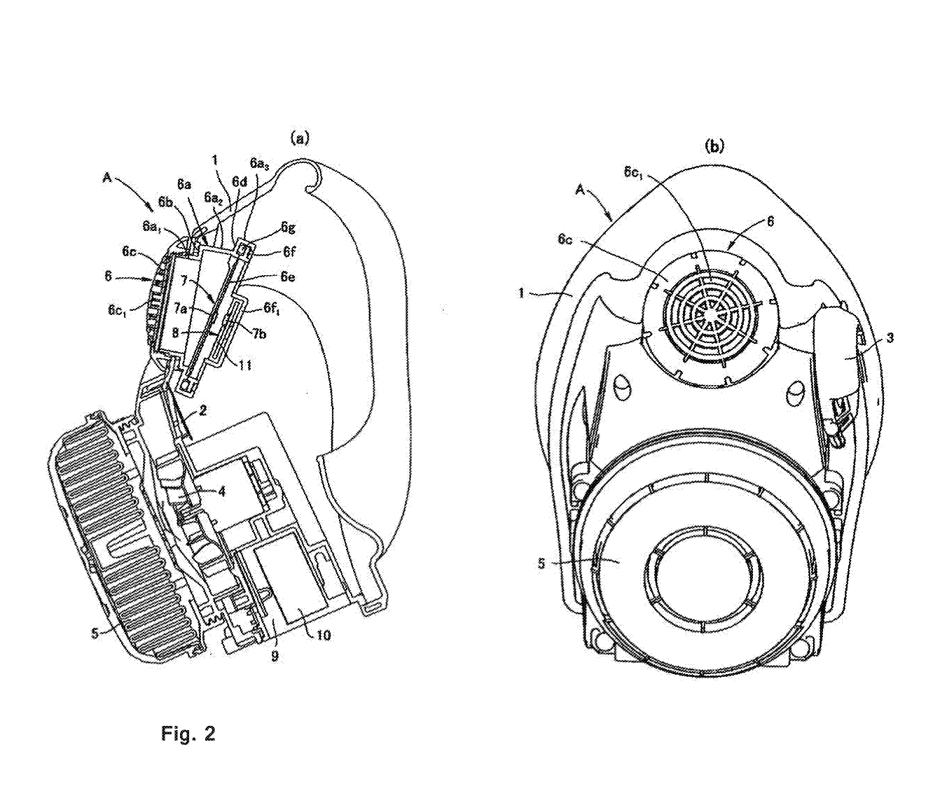

As shown in FIG. 2, a breathing apparatus A comprises a bowl-shaped half face type face piece 1 for covering a nose and a mouth of a user's face, an inhale valve 2 and an exhale valve 3 which are formed as reed valves, a motor fan 4 located upstream of the inhale valve 2 in relation to the inhale air flow so as to supply external air into the face piece 1 through the inhale valve 2, a filter 5 located upstream of the motor fan 4 in relation to the inhale air flow so as to clean the external air sucked into the motor fan 4, and a voice conductor 6. The inhale valve 2, the exhale valve 3, the motor fan 4, the filter 5 and the voice conductor 6 are attached to the face piece 1.

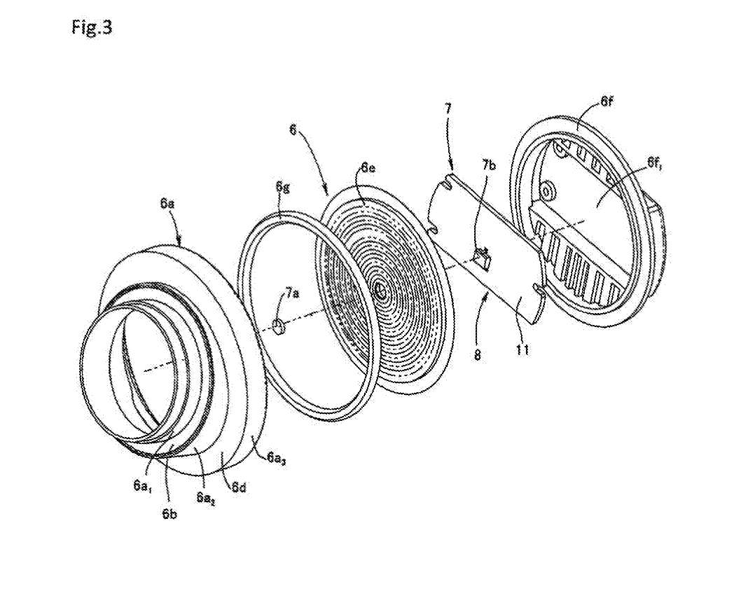

As shown in FIGS. 2 and 3, the voice conductor 6 comprises a cylindrical body 6a provided with a small diameter portion 6a₁, a middle diameter portion 6a₂ and a large diameter portion 6a₃ and fitting in an opening formed in the face piece 1 from the inside of the face piece at the small diameter portion 6a₁, a cup-shaped cover 6c screwed onto a portion of the small diameter portion 6a₁ projecting outside the face piece from the outside of the face piece so as to cooperate with an annular step part 6b between the small diameter portion 6a₁ and the middle diameter portion 6a₂, thereby clamping a part of the face piece 1 surrounding the opening and fixing the cylindrical body 6a to the face piece 1, a circular vibration member 6e abutting an annular step part 6d between the middle diameter portion 6a₂ and the large diameter portion 6a₃ at an outer peripheral portion from the inside of the face piece, an annular frame body 6f snapped in the large diameter portion 6a₃ so as to cooperate with the annular step part 6d, thereby clamping the outer peripheral portion of the vibration member 6e and fixing the vibration member 6e to the cylindrical body 6a, and an O-ring 6g for sealing the outer peripheral portion of the vibration member 6e clamped by the annular step part 6d and the annular frame body 6f. The cover 6c is provided with a plurality of openings 6c₁. The annular frame body 6f is provided with an arm 6f₁ extending through the center of the annular frame body so as to connect mutually facing two points on the annular frame body.

As shown in FIGS. 2 and 3, the vibration member 6e is a circular shaped formed sheet body provided with many coaxially disposed annular corrugations 6e₁ at a center portion exclusive of an outer peripheral portion clamped by the annular step 6d and the annular frame body 6f. The vibration member 6e has appropriate rigidity and can keep a flat condition even if not imparted with tensile force during non-loading time. The vibration member 6e is merely clamped by the annular step part 6d and the annular frame body 6f at outer peripheral portion so as to be fixed to the cylindrical body 6a without being imparted with tensile force.

The inhale valve 2, the motor fan 4, the filter 5 and the voice conductor 6 are attached to the front surface of the face piece 1. The exhale valve 3 is attached to a side surface of the face piece 1.

As shown in FIGS. 2 and 3, the breathing apparatus A comprises a breath monitoring apparatus 7. The breath monitoring apparatus 7 comprises a magnet 7a attached to the center of the vibration member 6e provided for the voice conductor 6, and a Hall element 7b attached to the longitudinal middle of the arm 6f₁ of the voice conductor 6 and opposing the magnet 7a at a predetermined distance.

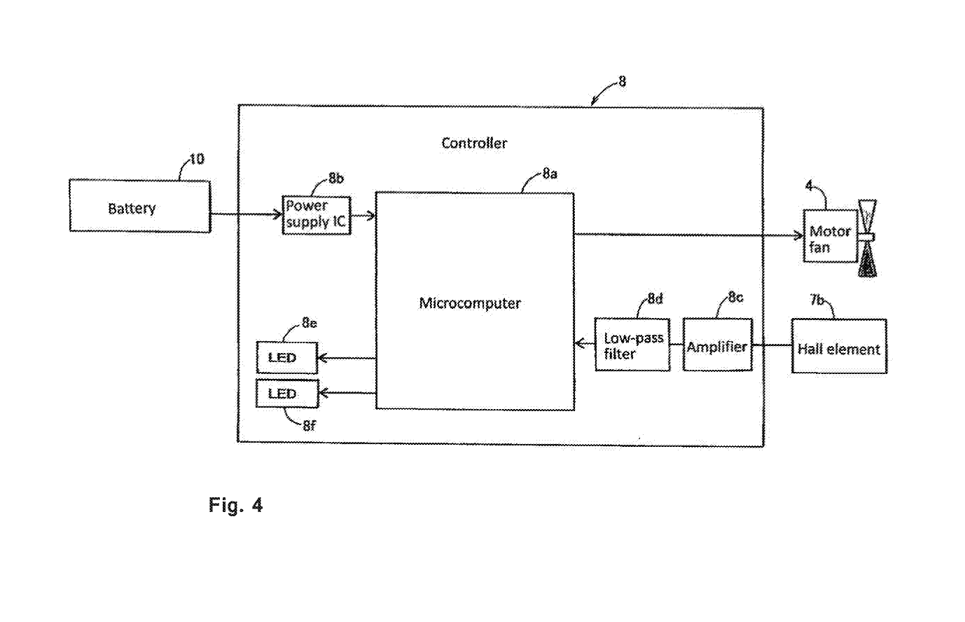

The breathing apparatus A comprises a controller 8. As shown in FIG. 4, the controller 8 is provided with a microcomputer 8a, a power supply IC 8b for stabilizing the voltage of power supplied to the microcomputer, an amplifier 8c for amplifying the detection signal of the Hall element 7b, a low-pass filter 8d for removing high frequency components from the amplified detection signal, and a pair of warning LEDs 8e and 8f. The Hall element 7b is connected to the microcomputer 8a through the amplifier 8c and the low-pass filter 8d. The motor fan 4 is connected to the microcomputer 8a. The microcomputer 8a is connected to a battery 10 installed in a battery storage compartment 9 through the power supply IC 8b

The controller 8 is mounted on a board 11 on which the Hall element 7b is mounted and attached to the arm body 6f₁ of the voice conductor 6.

As shown in FIGS. 2 and 3, the voice conductor 6, the breath monitoring apparatus 7 and the controller 8 are assembled into a unitary body so as to form a unit. The unit is detachably connected to an opening formed in the face piece 1.

Operation of the Breathing Apparatus A Will be Described.

When the breathing apparatus A is not in use, the internal pressure (gage pressure) of the face piece 1 is zero, so that the internal pressure and the external pressure applied to the vibration member 6e are in balance with each other; that is, the vibration member 6e is in a no load condition. In the following description, the internal pressure of the face piece 1 is gage pressure. The vibration member 6e is in the initial condition, wherein the vibration member 6e extends flat, the distance between the magnet 7a and the Hall element 7b becomes the initial value, and the magnetic flux density detected by the Hall element 7b also becomes the initial value.

When the internal pressure of the face piece 1 is positive, the vibration member 6e swells outward of the face piece 1. When the internal pressure of the face piece 1 is negative, the vibration member 6e subsides toward the internal space of the face piece 1.

When the breathing apparatus A is used, the battery 10 is installed in the battery storage compartment 9 so as to start the controller 8. The face piece 1 is put on the head of the user so as to cover a part of the face of the user including the nose and the mouth. The annular periphery of the face piece 1 tightly abuts the face of the user to prevent the external air from flowing into the face piece through the abutting portion between the annular periphery of the face piece and the face of the user.

In response to the exhale and inhale of the user, the internal pressure of the face piece 1 increases and decreases, pressure difference is generated between the internal pressure and the external pressure applied to the vibration member 6e, the vibration member 6e deflects from the initial condition, and the distance between the magnet 7a and the Hall element 7b changes from the initial value. The Hall element 7b detects the change of the magnetic flux density from the initial value caused by the aforementioned change of the distance so as to send a detection signal to the microcomputer 8a of the controller 8 through the amplifier 8c and the low-pass filter 8d. The microcomputer 8a recognizes that the breathing apparatus A was put on the head of the user when the magnetic flux density received from the Hall element 7b through the amplifier 8c and the low pass filter 8d changes by more than a predetermined level from the initial value, and starts the motor fan 4.

The microcomputer 8a controls the rotation speed of the motor fan 4 based on the detection signal received from the Hall element 7b through the amplifier 8c and the low pass filter 8d so that the internal pressure of the face piece 1 becomes positive and the vibration member 6e lies farther outside the face piece 1 after the deflection than in the initial condition.

During exhale, the internal pressure of the face piece 1 increases, the deflection of the vibration member 6e outward of the face piece 1 increases, the distance between the magnet 7a and the Hall element 7b increases, and the magnetic flux density detected by the Hall element 7b decreases. When the increment of the aforementioned distance from the initial value exceeds a predetermined level and the decrement of the magnetic flux density detected by the Hall element 7b from the initial value exceeds a predetermined level, the microcomputer 8a recognizes that the breathing is in exhaling condition so as to decrease the rotation speed of the motor fan 4 or stop the motor fan 4. As a result, electric power consumption is saved, discharge of the battery 10 is suppressed, and clogging of the filter 5 is suppressed. During exhale, the inhale valve 2 closes and the exhale valve 3 opens. The exhaled air is exhausted into the external environment through the exhale valve 3.

During inhale, the internal pressure of the face piece 1 decreases, the deflection of the vibration member 6e outward of the face piece 1 decreases, the distance between the magnet 7a and the Hall element 7b decreases, and the magnetic flux density detected by the Hall element 7b increases. When the increment of the aforementioned distance from the initial value becomes equal to or less than the predetermined level and the decrement of the magnetic flux density detected by the Hall element 7b from the initial value becomes equal to or less than the predetermined level, the microcomputer 8a recognizes that the breathing is in inhaling condition so as to increase the rotation speed of the motor fan 4. During inhale, the inhale valve 2 opens and the exhale valve 3 closes. External air is passed through the filter 5 to be freed of dust, sucked into the motor fan 4, and passed into the face piece 1 through the inhale valve 2. When the rotation speed of the motor fan 4 increases, flow rate of the air introduced into the face piece 1 increases, and the internal pressure of the face piece 1 is kept positive. Thus, the breathing of the user of the breathing apparatus becomes easy.

Airflow resistance of the filter 5 increases over time due to accumulation of dust. As a result, the internal pressure of the face piece 1 during inhale decreases over time even if the motor fan 4 is operated. Finally, the internal pressure of the face piece 1 becomes negative, the distance between the magnet 7a and the Hall element 7b becomes less than the initial value, and the magnetic flux density of the magnet 7a detected by the Hall element 7b increases beyond the initial value. When the magnetic flux density of the magnet 7a detected by the Hall element 7b increases beyond the initial value, the microcomputer 8a recognizes that the life of the filter 5 has expired due to clogging and activates the LEDs 8e and 8f to make them generate warning lights, thereby prompting the user of the breathing apparatus A to change the filter 5. When the filter 5 is changed, the internal pressure of the face piece 1 comes to be controlled again to become positive, and the function of the breathing apparatus A is restored.

When the user of the breathing apparatus A speaks, the vibration member 6e of the voice conductor 6 vibrates so as to emit the voice of the user of the breathing apparatus into the external environment. When the vibration member 6e of the voice conductor 6 resonates with the voice of the user of the breathing apparatus, high frequency vibration of the vibration member 6e of the voice conductor 6 may occur at an amplitude larger than that due to the breath of the user of the breathing apparatus. In this case, the Hall element 7b detects the high frequency vibration of the vibration member 6e, the motor fan 4 repeats increase/decrease of fan speed or ON/OFF in a short cycle based on the detection signal from the Hall element 7b, the battery 10 rapidly discharges, a brush of the motor fan rapidly wears down, and electronic components incorporated into the controller 8 rapidly deteriorate. When the detection signal of the Hall element 7b is input to the microcomputer 8a through the low-pass filter 8d, high frequency components due to resonance of the voice of the user of the breathing apparatus and the vibration member 6e of the voice conductor 6 are removed from the detection signal, so that only low frequency components due to the breath of the user of the breathing apparatus are input to the controller 8. Thus, rapid discharge of the battery 10, rapid wearing of the brush of the motor fan 4, and rapid deterioration of the electronic components incorporated into the controller 8 due to the said high frequency components are prevented.

When the breathing apparatus A is removed from the head of the user, the internal pressure and the external pressure applied to the vibration member 6e come into balance with each other, the vibration member 6e returns to the initial condition, wherein no load is applied to the vibration member 6e, the distance between the magnet 7a and the Hall element 7b returns to the initial value, and the magnetic flux density of the magnet 7a detected by the Hall element 7b returns to the initial value. When the magnetic flux density of the magnet 7a received from the Hall element 7b remains at the initial value for a predetermined time, the microcomputer 8a recognizes that the breathing apparatus A was removed from the head of the user and stops the motor fan 4.

In the breathing apparatus A, the Hall element 7b constituting a part of the breath monitoring apparatus 7 need not be located in an inhale passage or an exhale passage because the breath monitoring apparatus 7 does not comprise the inhale valve 2 or the exhale valve 3. Therefore, particulates of dust, water, etc. contaminating the inhaled air or the exhaled air do not readily adhere to the Hall element 7b or foul it. Therefore, deterioration of the accuracy of the breath monitoring apparatus 7 with aging does not readily occur.

With the breathing apparatus A, the user need not manually operate an ON/OFF switch of the motor fan 4 after he or she puts on the breathing apparatus A because the motor fan 4 automatically starts when he or she puts on the breathing apparatus A to start breathing and automatically stops when he or she takes off the breathing apparatus. As a result, the convenience of the breathing apparatus A increases.

In the breathing apparatus A, the vibration member 6e of the voice conductor 6 is used also as an element of the breath monitoring apparatus 7. Thus, the number of the elements of the present breathing apparatus becomes less than that of the breathing apparatus fabricated as an actual product according to Patent Document No. 1, wherein the breath monitoring apparatus 7 and the voice conductor 6 are attached to the face piece independently.

The Hall element 7b provided for the breathing apparatus A is a magnetometric sensor. Therefore, the accuracy of detection by the Hall element 7b is not readily decreased even if particulates of dust, water, etc. contaminating the internal air of the face piece 1 adhere to the Hall element 7b. Therefore, deterioration of the accuracy of the breath monitoring apparatus 7 with aging does not readily occur in the breathing apparatus A.

The vibration member 6e made of a formed sheet body provided with many coaxially disposed annular corrugations 6e₁ at a center portion exclusive of an outer peripheral portion clamped by the annular step part 6d and the annular frame body 6f has an appropriate rigidity, so that it can keep a flat condition without being imparted with tensile force during non-loading time; that is, it does not become loose even when not imparted with tensile force during non-loading time. Therefore, the vibration member 6e can effectively radiate the voice of a user of the breathing apparatus to the outside. Although the structure of the vibration member 6e comprising the formed sheet body is more complicated than that of a vibration member comprising a simple flat sheet, the body of the voice conductor as a whole becomes simpler than a voice conductor comprising a vibration member made of a simple flat sheet because the voice conductor does not need any member for imparting tensile force to the vibration member 6e.

In the breathing apparatus A, the detection signal from the Hall element 7b is input to the microcomputer 8a through the low-pass filter 8d. Thus, rapid discharge of the battery 10, rapid wearing of the brush of the motor fan, and rapid deterioration of the electronic components incorporated into the controller due to resonance of the voice of the user of the breathing apparatus and the vibration member 6e of the voice conductor are prevented.

In the breathing apparatus A, the detection signal from the Hall element 7b is amplified by the amplifier 8c and then input to the microcomputer 8a. Deflection of the vibration member 6e of the voice conductor due to fluctuation of internal pressure of the face piece caused by breathing is small. Therefore, the detection signal from the Hall element 7b is desirably amplified by the amplifier 8c and then input to the microcomputer 8a so as to increase the accuracy of motor fan 4 control.

In the breathing apparatus A, the voice conductor 6, the breath monitoring apparatus 7 and the controller 8 are assembled as a unitary body so as to form a unit, and the unit is detachably connected to the hole formed in the face piece 1. Thus, the work of assembling of breathing apparatus A becomes easy.

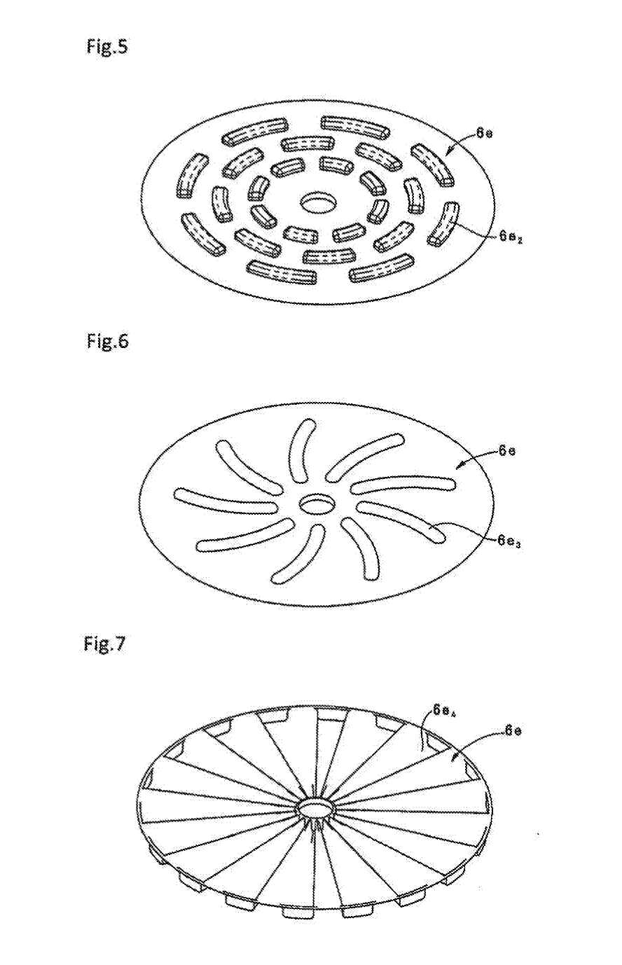

Rather than forming the center portion of the vibration member with many coaxially disposed annular corrugations 6e₁, it is possible instead to form it with annular projections (annular concaves as seen from the opposite surface), or many intermittent annular projections (intermittent annular concaves as seen from the opposite surface) 6e₂ as shown in FIG. 5, or many radial concaves (radial projections as seen from the opposite surface) 6e₃, 6e₄ as shown in FIGS. 6, 7 to thereby appropriately enhance the rigidity of the vibration member 6e and enable it to keep a flat condition even if not imparted with tensile force during no load condition.

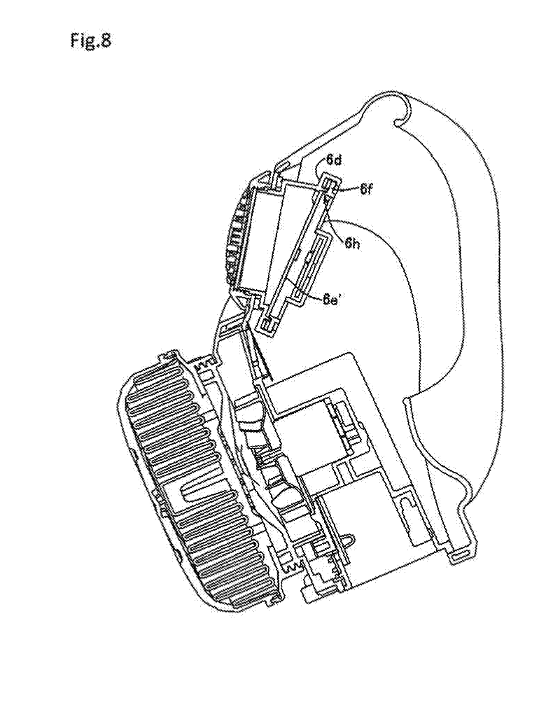

As shown in FIG. 8, the voice conductor can comprise a vibration member 6e′ made of a sheet of simple structure. In this case, clamping parts constituted of the annular step 6d and the annular frame body 6f and clamping the vibration member 6e′ should be two cutting blades 6h like scissors so as to clamp the outer periphery of the vibration member 6e′ between the two cutting blades 6h and thereby impart tensile force to the vibration member 6e′ and enable the vibration member 6e′ to keep a flat condition during non-load time. The vibration member 6e′ comprising a simple sheet body has an advantage in that its structure is simple. However, it becomes necessary to provide the voice conductor 6 with a member for imparting tensile force to the vibration member 6e′. Thus, the structure of the voice conductor 6 becomes complicated as a whole. Moreover, the vibration member 6e′ is easily creased with wrinkles when it is imparted with tensile force.

Rather than installing the amplifier 8c, it is possible instead to enhance the detection signal resolution of the microcomputer 8a, or increase the magnetic force of the magnet 7a attached to the vibration member 6e of the voice conductor 6, or enhance the sensitivity of the Hall element 7b attached to the annular frame body 6f.

In the aforementioned embodiment, 7a is a magnet and 7b is a Hall element, and displacement of the vibration member 6e is detected by the magnet 7a and the Hall element 7b. It is possible instead to make 7a a reflector and 7b an optical sensor provided with a light emitting member and a light receiving member, so as to detect deflection of the vibration member 6e by the reflector 7a and the optical sensor 7b.

It is possible to generate warning sounds instead of warning lights for prompting the user of the breathing apparatus A to change the filter 5.

The face piece 1 can be a full face type face piece for covering whole face.

### INDUSTRIAL APPLICABILITY

The present invention can be widely used for breathing apparatuses comprising a face piece for covering the whole face or part of the face, an inhale valve, an exhale valve, a motor fan for supplying external air into the face piece through the inhale valve, a filter for cleaning the external air sucked into the motor fan, a breath monitoring apparatus not comprising the inhale valve or the exhale valve, and a controller for controlling the operation of the motor fan synchronously with the breath based on the detection signal from the breath monitoring apparatus, wherein the inhale valve, the exhale valve, the motor fan, the filter, the breath monitoring apparatus and the controller are attached to the face piece.

### BRIEF DESCRIPTION OF THE REFERENCE NUMERALS

A Breathing apparatus
1 Face piece
2 Inhale valve
3 Exhale valve
4 Motor fan
5 Filter
6 Voice conductor
6e, 6e′ Vibration member
7 Breath monitoring apparatus
7a Magnet, Reflector
7b Hall element, Optical sensor
8 Controller
8c Amplifier
8d Low-pass filter

1. A breathing apparatus comprising a face piece for covering the whole face or part of the face, an inhale valve, an exhale valve, a voice conductor, a motor fan for supplying external air into the face piece through the inhale valve, a filter for cleaning the external air sucked into the motor fan, a breath monitoring apparatus not comprising the inhale valve or the exhale valve, and a controller for controlling the operation of the motor fan synchronously with the breath based on the detection signal from the breath monitoring apparatus, wherein the inhale valve, the exhale valve, the voice conductor, the motor fan, the filter, the breath monitoring apparatus and the controller are attached to the face piece, and wherein the breath monitoring apparatus detects deflection of a vibration member of the voice conductor.

2. A breathing apparatus of claim 1, wherein the breath monitoring apparatus comprises a magnet attached to the vibration member of the voice conductor and a Hall element disposed opposite to the magnet.

3. A breathing apparatus of claim 1, wherein the breath monitoring apparatus comprises a reflection member attached to the vibration member of the voice conductor and an optical sensor provided with a light emitting member and a light receiving member and disposed opposite to the reflection member.

4. A breathing apparatus of claim 1, wherein the vibration member of the voice conductor is a formed sheet body capable of keeping a flat condition without being imparted with tensile force during non-loading time

5. A breathing apparatus of claim 4, wherein the vibration member of the voice conductor is a circular shaped formed sheet body provided with many coaxially disposed annular corrugations at a center portion exclusive of an outer peripheral portion.

6. A breathing apparatus of claim 1, wherein the vibration member of the voice conductor is a sheet body capable of keeping a flat condition, while being imparted tensile force during non-loading time.

7. A breathing apparatus of claim 1, wherein the detection signal from the breath monitoring apparatus is input to the controller through a low-pass filter.

8. A breathing apparatus of claim 1, wherein the detection signal from the breath monitoring apparatus is input to the controller through an amplifier.

9. A breathing apparatus of claim 1, wherein the breath monitoring apparatus, the voice conductor and the controller are assembled as a unitary body so as to form a unit, and the unit is detachably connected to an opening formed in the face piece.
